(19) United States
(12) Patent Application Publication
(10) Pub. No.: US 2015/0328552 A1
(43) Pub. Date: Nov. 19, 2015

(54) SYSTEMS AND METHODS FOR ACHIEVING USER ENGAGEMENT IN AN ONLINE GAMING ENVIRONMENT USING INCENTIVES

(71) Applicant: Limited Liability Company Mail.ru Games, Moscow (RU)

(72) Inventors: Andrii LVOV, Kiev (UA); Maksym MARTYNENKO, Kiev (UA)

(21) Appl. No.: 14/662,554

(22) Filed: Mar. 19, 2015

Related U.S. Application Data
(63) Continuation of application No. PCT/RU2012/000769, filed on Sep. 19, 2012.

(51) Int. Cl. A63F 13/79; A63F 13/23; A63F 13/825; A63F 13/32; A63F 13/95; A63F 13/77; A63F 13/25

(52) U.S. Cl. CPC A63F 13/79; A63F 13/77; A63F 13/23; A63F 13/25; A63F 13/32; A63F 13/95; A63F 13/825

(57) ABSTRACT

A computer-implemented method performed in a system incorporating a central processing unit, a memory and a network interface, the method involves: receiving a request from a client system operated by a user, the request containing information on the identity of the user; using the received information on the identity of the user to prepare a user-specific game incentive information; providing the prepared user-specific game incentive information to the client system, the user-specific information causing the client system to display a user interface for a mini-game to the user; receiving from the client system the results of the mini-game played by the user; awarding a game incentive to the user based on the received results of the mini-game played by the user; storing information on the awarded incentive in a data store; providing the information on the awarded incentive to the client system; and causing the information on the awarded incentive to be displayed to the user.

### BACKGROUND OF THE INVENTION

1. Field of the Invention

This invention relates in general to systems and methods for implementing online gaming environments and, more particularly, to providing systems and methods for keeping Internet users engaged in online games using game incentives.

2. Description of the Related Art

Playing online games has become very popular among Internet users. Many online games are based on a virtual gaming environment, which, to varying degree, may resemble the real world. The gaming environment enables the playing user to control a character operating in the game's virtual world. The user-controller virtual character (sometimes called avatar) can be considered a virtual representation of the playing user in the gaming environment. In many online games, the player's virtual character is able to find certain virtual assets or buy them in exchange for a virtual currency. After obtaining the assets, the character may own them throughout the game and use them for various purposes (building a virtual house, etc.) or exchange them for other virtual assets or benefits within the game. Thus, it is desirable for a user to have more virtual assets in order to be more successful in the game. In many Internet games, the user can exchange real world currency for the virtual currency usable within the game. This is done by enabling a user to make a payment to the game operator, which is credited to the user's game character in a form of a sum of virtual currency at a predetermined exchange rate.

Monetization of online games is based on the aggregate time spent by all the users actively playing such games. Thus, it is advantageous from the game monetization point of view to keep users engaged in the games thereby increasing the total online user playing time. Therefore, as it would be appreciated by those of skill in the art, it is desirable to develop novel systems and methods for keeping users engaged in online games. In addition, it is desirable to encourage users to make more purchases of the game's virtual currency.

### SUMMARY OF THE INVENTION

The inventive methodology is directed to methods and systems that substantially obviate one or more of the above and other problems associated with conventional techniques for implementing online gaming environments.

In accordance with one aspect of the present invention, there is provided a computer-implemented method performed in a system comprising a central processing unit, a memory and a network interface, the method comprising: receiving a request from a client system operated by a user, the request containing information on the identity of the user, the request being issued by the client system in connection with a game played by the user; using the received information on the identity of the user to prepare a user-specific game incentive information; providing the prepared user-specific game incentive information to the client system, the user-specific information causing the client system to display a user interface for a mini-game to the user; receiving from the client system the results of the mini-game played by the user; awarding a game incentive to the user based on the received results of the mini-game played by the user; storing information on the awarded game incentive in a data store; providing the information on the awarded game incentive to the client system; and causing the information on the awarded game incentive to be displayed to the user.

In accordance with another aspect of the present invention, there is provided a computerized system comprising a central processing unit, a memory and a network interface, the memory storing a set of instructions causing the central processing unit to perform a method comprising: receiving a request from a client system operated by a user, the request containing information on the identity of the user, the request being issued by the client system in connection with a game played by the user; using the received information on the identity of the user to prepare a user-specific game incentive information; providing the prepared user-specific game incentive information to the client system, the user-specific information causing the client system to display a user interface for a mini-game to the user; receiving from the client system the results of the mini-game played by the user; awarding a game incentive to the user based on the received results of the mini-game played by the user; storing information on the awarded game incentive in a data store; providing the information on the awarded game incentive to the client system; and causing the information on the awarded game incentive to be displayed to the user.

In accordance with a further aspect of the present invention, there is provided a tangible computer-readable medium embodying a set of computer instructions, which, when executed by a system comprising a central processing unit, a memory and a network interface, cause the system to perform a method comprising: receiving a request from a client system operated by a user, the request containing information on the identity of the user, the request being issued by the client system in connection with a game played by the user; using the received information on the identity of the user to prepare a user-specific game incentive information; providing the prepared user-specific game incentive information to the client system, the user-specific information causing the client system to display a user interface for a mini-game to the user; receiving from the client system the results of the mini-game played by the user; awarding a game incentive to the user based on the received results of the mini-game played by the user; storing information on the awarded game incentive in a data store; providing the information on the awarded game incentive to the client system; and causing the information on the awarded game incentive to be displayed to the user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary configuration of an online gaming system.

FIG. 2 illustrates an exemplary operating sequence of an embodiment of an inventive system for keeping the Internet users engaged in online games using various incentives.

FIG. 3 illustrates an exemplary logical diagram of interaction between various modules of an embodiment of an inventive system for keeping the Internet users engaged in online games using various incentives.

FIG. 4 illustrates an operating sequence of another exemplary embodiment of an inventive system for keeping the Internet users engaged in online games using various incentives.

FIG. 5 illustrates a logical diagram of interaction between various modules of another exemplary embodiment of an inventive system for keeping the Internet users engaged in online games using various incentives.

FIG. 6 illustrates an operating sequence of yet another exemplary embodiment of an inventive system for keeping the Internet users engaged in online games using various incentives.

FIG. 7 illustrates a logical diagram of interaction between various modules of yet another exemplary embodiment of an inventive system for keeping the Internet users engaged in online games using various incentives.

FIG. 8 illustrates an operating sequence of yet another exemplary embodiment of an inventive system for keeping the Internet users engaged in online games using various incentives.

FIG. 9 illustrates a logical diagram of interaction between various modules of yet another exemplary embodiment of an inventive system for keeping the Internet users engaged in online games using various incentives.

FIG. 10 illustrates an operating sequence of yet another exemplary embodiment of an inventive system for keeping the Internet users engaged in online games using various incentives.

FIG. 11 illustrates a logical diagram of interaction between various modules of yet another exemplary embodiment of an inventive system for keeping the Internet users engaged in online games using various incentives.

FIG. 12 illustrates an operating sequence of yet another exemplary embodiment of an inventive system for keeping the Internet users engaged in online games using various incentives.

FIG. 13 illustrates a logical diagram of interaction between various modules of yet another exemplary embodiment of an inventive system for keeping the Internet users engaged in online games using various incentives.

FIG. 14 illustrates an operating sequence of yet another exemplary embodiment of an inventive system for keeping the Internet users engaged in online games using various incentives.

FIG. 15 illustrates a logical diagram of interaction between various modules of yet another exemplary embodiment of an inventive system for keeping the Internet users engaged in online games using various incentives.

FIG. 16 illustrates an operating sequence of yet another exemplary embodiment of an inventive system for keeping the Internet users engaged in online games using various incentives.

FIG. 17 illustrates a logical diagram of interaction between various modules of yet another exemplary embodiment of an inventive system for keeping the Internet users engaged in online games using various incentives.

FIG. 18 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Aspects of the present invention provide systems and methods for keeping the Internet users engaged in online games using various game incentives to maximize monetization.

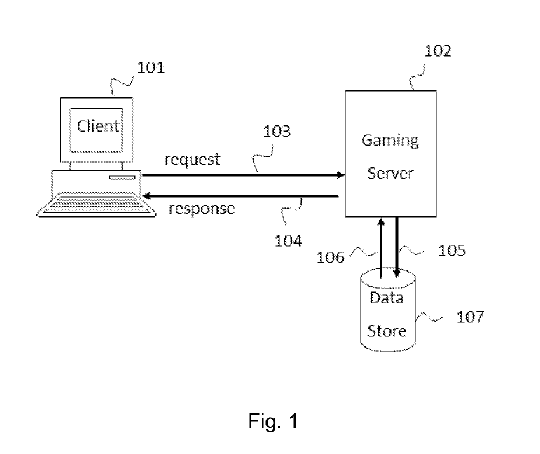

FIG. 1 illustrates an exemplary configuration of an online gaming system. In the shown exemplary configuration, a user (not shown) is using client computer system 101 to access the gaming server 102. The communication between the gaming server 102 and the client 101 is performed in a form of network requests 103 and responses 104, which may be sent using any now known or later developed network communication protocol, such as HTTP. To this end, the gaming server 102 may include a web service portion (not shown) in order to receive and handle the incoming client requests. By way of example and not limitation, the web service portion may be implemented using Apache web server, Microsoft Windows Server, Sun web server, Google web server, and/or Nginx web server, all of which are well known to persons of ordinary skill in the art, or any other suitable now known or later developed web server product.

In one or more embodiments, the gaming server 102 may be associated with a data store 107, configured for storing various data related to the user's gaming session with the server 102. The gaming server 102 may issue requests 105 for data stored in the data store 107 and receive responses 106 therefrom. The data store 107 may be implemented in a form of a database, such as a relation database, a file system or any other suitable storage means. In one or more embodiments, the data store may be implemented based on any now known or later developed type of database management system, such as the aforesaid relational database management system, including, without limitation, MySQL, Oracle, SQL Server, DB2, SQL Anywhere, PostgreSQL, SQLite, Firebird and/or MaxDB, which are well-known to persons of skill in the art. In an alternative embodiment, a cloud-based distributed database, such as Amazon Relational Database Service (Amazon RDS), well known to persons of ordinary skill in the art, may also be used to implement the data store 107.

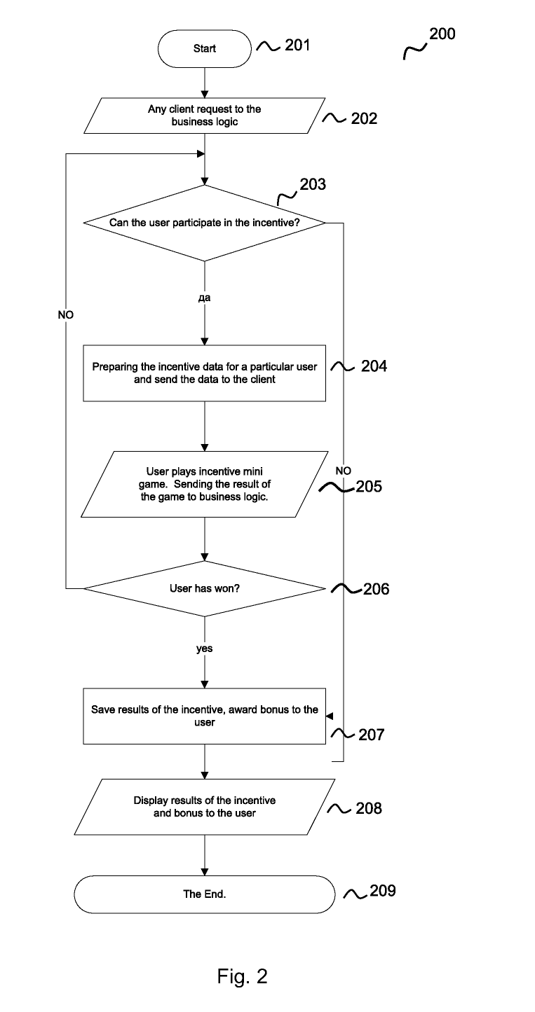

FIG. 2 illustrates an exemplary operating sequence 200 of an embodiment of an inventive system for keeping the Internet users engaged in online games using various incentives. The sequence starts with step 201. At step 202, the server 102 receives a request 103 from the client 101. At step 203, the inventive software residing on the server 102 determines whether the user is eligible to take part in the game incentive. Such determination may be performed based on user's current status in the game and his or her past activities within the game. For example, if the user participated in a number of incentives greater than predetermined threshold over a predetermined time period, the user may not be eligible to participate in the current incentive. If it is determined at step 203 that the user is eligible to participate in the incentive, the sequence proceeds to 204. At this step, the data associated with the incentive is prepared based on the identity of the specific user. In one or more embodiments, the user identity may be determined based on the content of the request. After preparation of the aforesaid incentive-related data, it is being sent over the network to the client 101.

At step 205, the incentive-related data is received by the client and the client is configured using the received incentive data to enable the user to engage in an incentive mini-game. After the completion of the aforesaid mini-game, the results thereof are sent from the client 101 to the server 102. At step 206, the inventive software operating on the server 102 determines whether the user succeeded in the mini-game. In this case, operation proceeds to step 207, whereupon the system awards the incentive to the user. Thereafter, at step 208, the information on the results of the mini-game and the awarded incentive (if any) is displayed on the display unit of the client 101 to the user. The described operating sequence terminates at step 209.

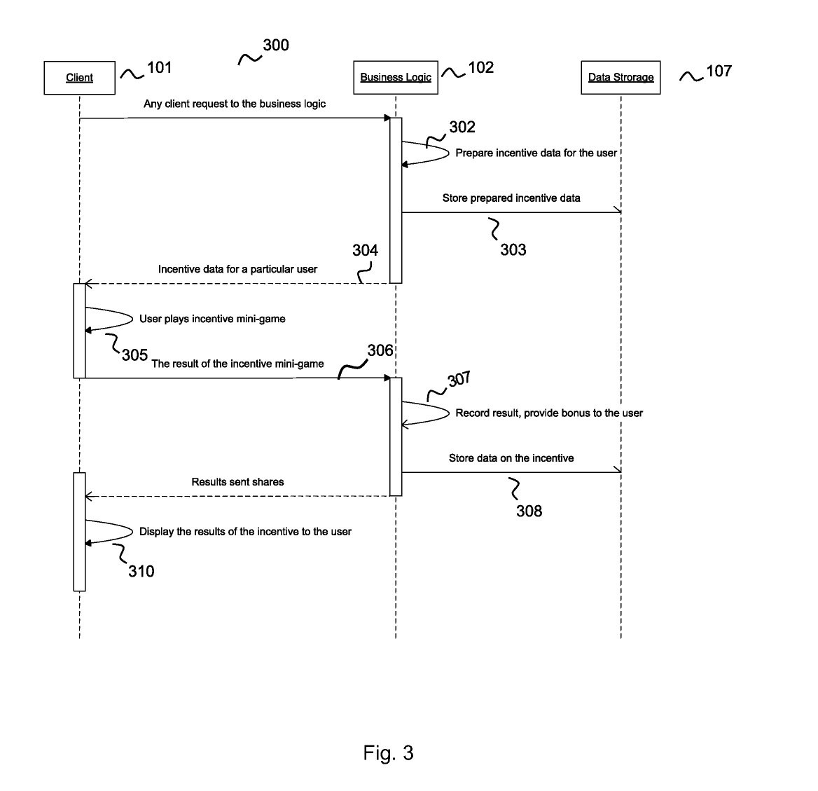

FIG. 3 illustrates an exemplary logical diagram 300 of interaction between various modules of an embodiment of an inventive system for keeping the Internet users engaged in online games using various incentives. Specifically, the interaction is shown between client 101, gaming server 102 and data store 107. The process is initiated when the client 101 sends a request 301 to the gaming server 102 executing the inventive software. The incentive-related data 302 is then prepared for the specific user who originated the request 301 at the gaming server 102. The data 303 representing the status of the incentive is then stored at the data store 107.

Thereafter, the incentive-related data 304 customized for the specific user is sent to the client 101. The received data configures the client 101 to enable the user to play an incentive mini-game 305. After the completion of the aforesaid mini-game, the results thereof 306 are sent from the client computer 101 back to the server 102. At the server 102, the received results of the mini-game are used to award an incentive to the user, see 307. After that, the information 308 on the user's mini-game completion status as well as the awarded incentive are stored in the data store 107. Subsequently, the information 309 on the awarded incentive is sent back to the client computer system 101, where it is displayed to the user, see operation 310.

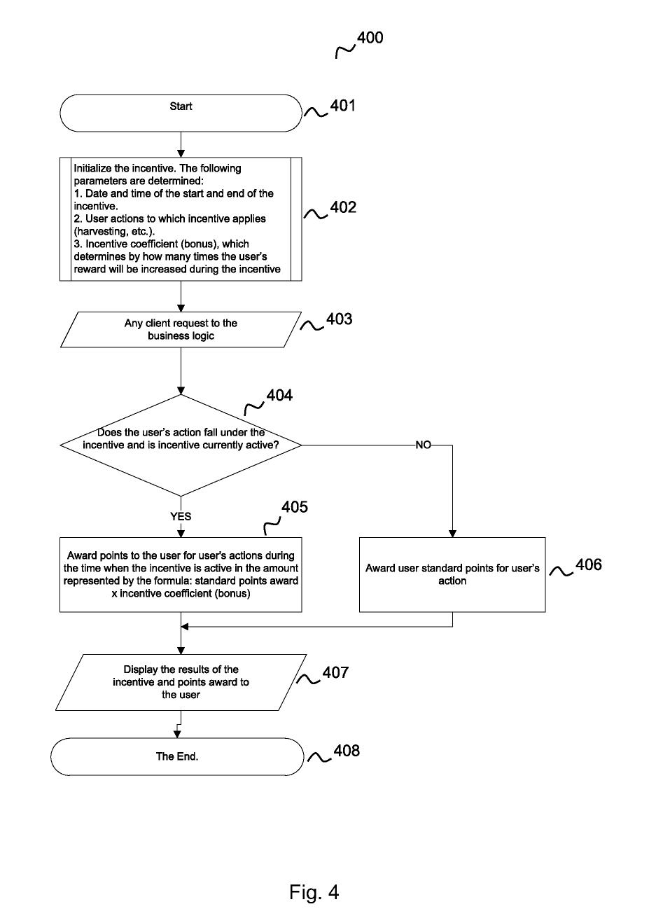

FIG. 4 illustrates an operating sequence 400 of another exemplary embodiment of an inventive system for keeping the Internet users engaged in online games using various incentives. The sequence starts with step 401. At step 402, the incentive initialization operation is performed. Specifically, the inventive software determines: 1) the start and end date/time for the incentive; 2) action required from the user to participate in the incentive; 3) an incentive coefficient (bonus). In one or more embodiments, the start and/or end date/time for the incentive may be randomly generated by the inventive software. The generated bonus determines the multiplier for awarding additional (enhanced) points for user's actions during the time when the incentive is active. At step 403, the server 102 receives a request 103 from the client 101. At step 404, the inventive software operating on the server determines whether the actions of the user make him or her eligible for the incentive and whether the incentive is currently active. If the answer to both questions is in the affirmative, the operation proceeds to step 405. Otherwise, step 406 is performed. At step 405, points are awarded to the user for user's actions during the time when the incentive is active in the amount represented by the formula: standard points award x incentive coefficient (bonus). On the other hand, at step 406, the user is provided with a standard pints award for user's actions. At step 407, the information on the awarded points is provided to the user. The described operating sequence terminates at step 408.

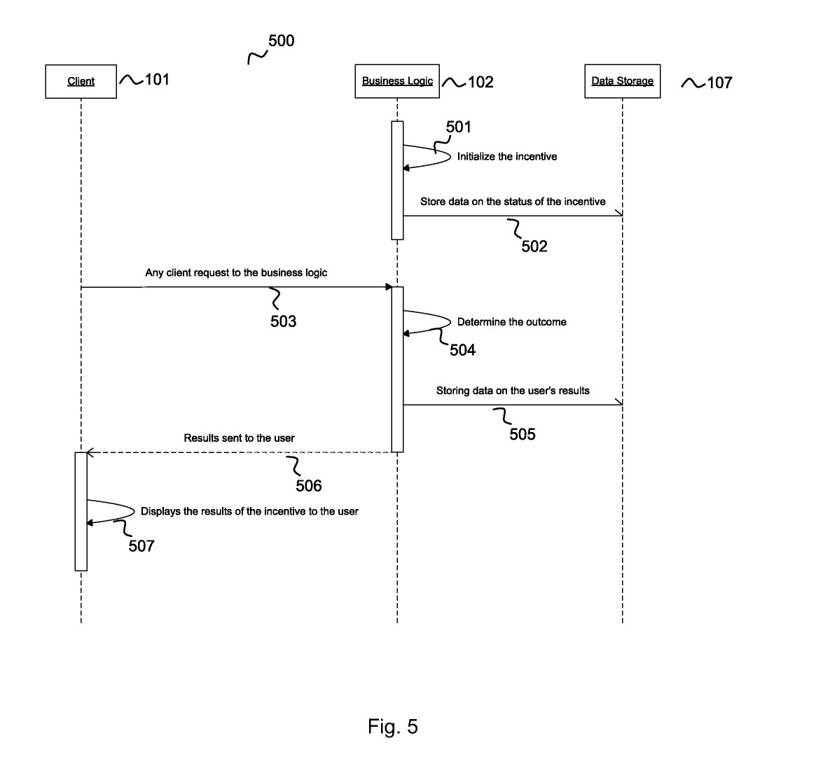

FIG. 5 illustrates an exemplary logical diagram 500 of interaction between client 101, gaming server 102 and data store 107 of an embodiment of an inventive system for keeping the Internet users engaged in online games using various incentives. The process is initiated when the incentive initialization operation is performed at step 501. The incentive-related information generated during the initialization step is stored by the server 102 in the data store 107, see operation 502. In one or more embodiments, the received request contains information on user's actions. At step 503, the appropriate points are awarded to the user for user's actions based upon whether or not the incentive is active and whether or not user's actions qualify for the incentive. The information on the awarded points is stored in the data store 107, see operation 505. Subsequently, the information on the awarded points is provided to the client computer system 101, see operation 506, where it is displayed to the user, see operation 507.

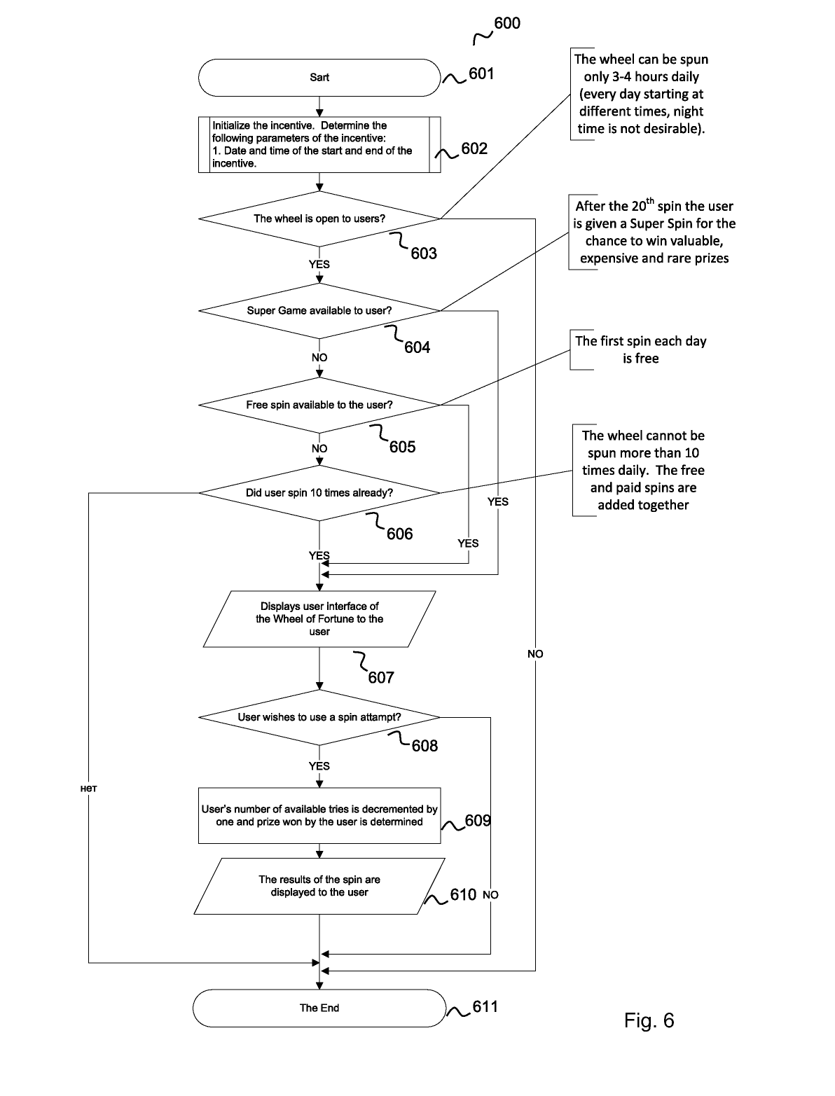

FIG. 6 illustrates an operating sequence 600 of another exemplary embodiment of an inventive system for keeping the Internet users engaged in online games using various incentives. In the embodiments shown in FIG. 6, the user is provided with a chance to spin a wheel of fortune (roulette) to potentially receive an expensive or rare virtual item. The sequence starts with step 601. At step 602, the incentive initialization operation is performed. Specifically, at step 602 the inventive software determines the start and end date/time for the incentive. In one or more embodiments, the start and/or end date/time for the incentive may be randomly generated by the inventive software. In one or more embodiments, the total time when this incentive is available to the user may be between 3 and 4 hours per day. In one or more embodiments, the first spin of the wheel is free for all users. All subsequent spins are paid. In one or more embodiments, each subsequent spin is more expensive than the previous one and the prizes available in each spin may also increase in price. In one or more embodiments, the maximum number of daily spins of the wheel is 10. In one or more embodiments, the 20^{th} spin is a free “super spin” with especially expensive and rare prizes.

Turning back to the operating sequence of FIG. 6, at step 603, the inventive software determines whether the wheel of fortune is open to the user. If so, the operation proceeds to step 604, whereupon the system determines whether the user is eligible for the “super spin.” If not, the operation proceeds to step 605. At that step, the inventive software determines whether or not the user is eligible for a free spin of the wheel. If not, the inventive software checks whether the user already spun the wheel 10 times. If the outcome of any of the steps 604-606 is “yes”, at step 607 the inventive software sends a transmission to the client computer system 101 causing a representation of the wheel of fortune to be displayed to the user on the display of the client computer system 101 and requesting the user to indicate whether or not he or she wishes to use the wheel spin attempt. If the user indicates, at step 608, that he or she will spin the wheel, the system performs the virtual wheel spin and determines the virtual prize won by the user. At step 610, the information on the won incentive is provided to the user. The described operating sequence terminates at step 611.

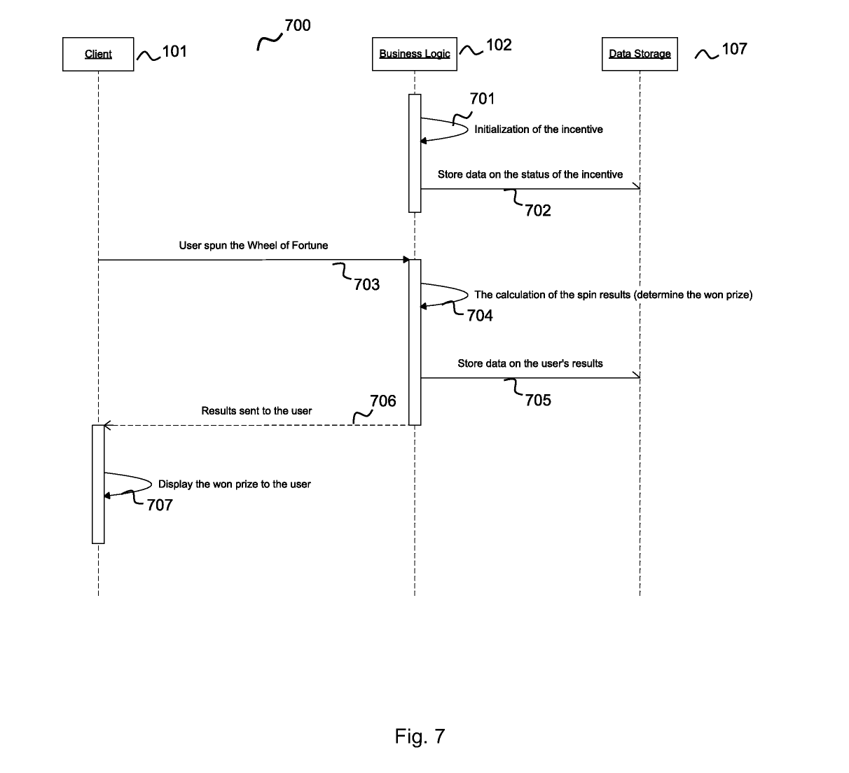

FIG. 7 illustrates an exemplary logical diagram 700 of interaction between client 101, gaming server 102 and data store 107 of an embodiment of an inventive system for keeping the Internet users engaged in online games using various incentives. The logical diagram 700 generally corresponds to the operating sequence 600 shown in FIG. 6. As in FIG. 6, in the embodiments shown in FIG. 7, the user is provided with a chance to spin a wheel of fortune (roulette) to potentially receive an expensive or rare virtual item. The process is initiated when the incentive initialization operation is performed at step 701. The incentive-related information generated during the initialization step is stored by the server 102 in the data store 107, see operation 702. At operation 703, the user performs the spin of the wheel of fortune and the information on this action is received by the gaming server 102 from the client 101. The results of the wheel spin and the prize won by the user are determined in operation 704 based on the information received in operation 703. Subsequently, the information on the results of the wheel spin is stored by the server 102 in the data store 107, see operation 705. At step 706, the information on the won incentive is provided by the gaming server 102 to the user's client computer system 101, where it is displayed to the user, see operation 707 in FIG. 7.

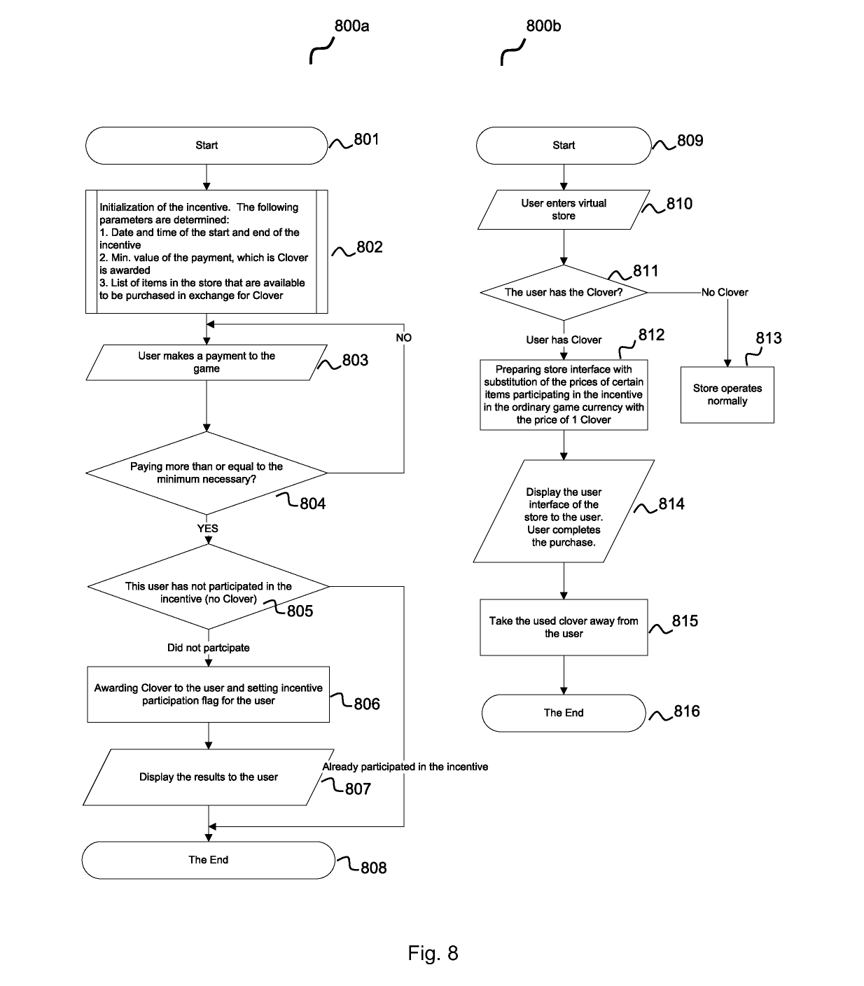

FIG. 8 illustrates an operating sequence 800a of another exemplary embodiment of an inventive system for keeping the Internet users engaged in online games using various incentives. In the embodiments shown in FIG. 8, the user is provided encouraged to make a small payment in order to receive an additional bonus in a form of a virtual coupon or a virtual ticket. In one or more embodiments, the bonus is designed to allow the user to receive any item in a game virtual store, except for maybe the most expensive and/or exclusive items in the game. In one or more embodiments, the incentive works several times a month. In one or more embodiments, once the user receives the bonus, it must be used in the very next virtual purchase, forcing the user to use it without delay.

The sequence shown in FIG. 8 starts with step 801. At step 802, the incentive initialization operation is performed. Specifically, the inventive software determines: 1) the start and end date/time for the incentive; 2) the minimal payment eligible for receiving the bonus; 3) a list of items that could be exchanged for the coupon or ticket received by the user. In one or more embodiments, the start and/or end date/time for the incentive may be randomly generated by the inventive software.

At step 803, the user makes the mini-payment. At step 804, the inventive software determines whether the payment satisfies the predetermined minimum amount. If so, the inventive software determines, at step 805, whether the user has already used this incentive. If so, the user is not eligible for the bonus and the operation terminates. If the user has not yet used this incentive, the bonus is awarded to the user and the fact of user's participation in the incentive is recorded. At step 807, the information on the awarded bonus is provided to the user. The described operating sequence terminates at step 808.

Also shown in FIG. 8 is an exemplary operating sequence 800b of a process for enabling a user to use the awarded virtual coupon or a ticket. The sequence shown in FIG. 8 starts with step 809. At step 810, the user's game character enters the game's virtual store. At step 811, the inventive software determines whether the user is in possession of a previously awarded virtual coupon or a ticket. If yes, then the inventive software operates to change prices of all the virtual items in the virtual store for one user's coupon, see step 812. Otherwise, a standard store interface is generated, see step 813. At step 814, the store interface is displayed to the user by the client computer system 101 and enables the user to make the purchase in exchange for the awarded coupon or ticket, whereupon at step 815, the used bonus is removed from the user's account. The described operating sequence terminates at step 816.

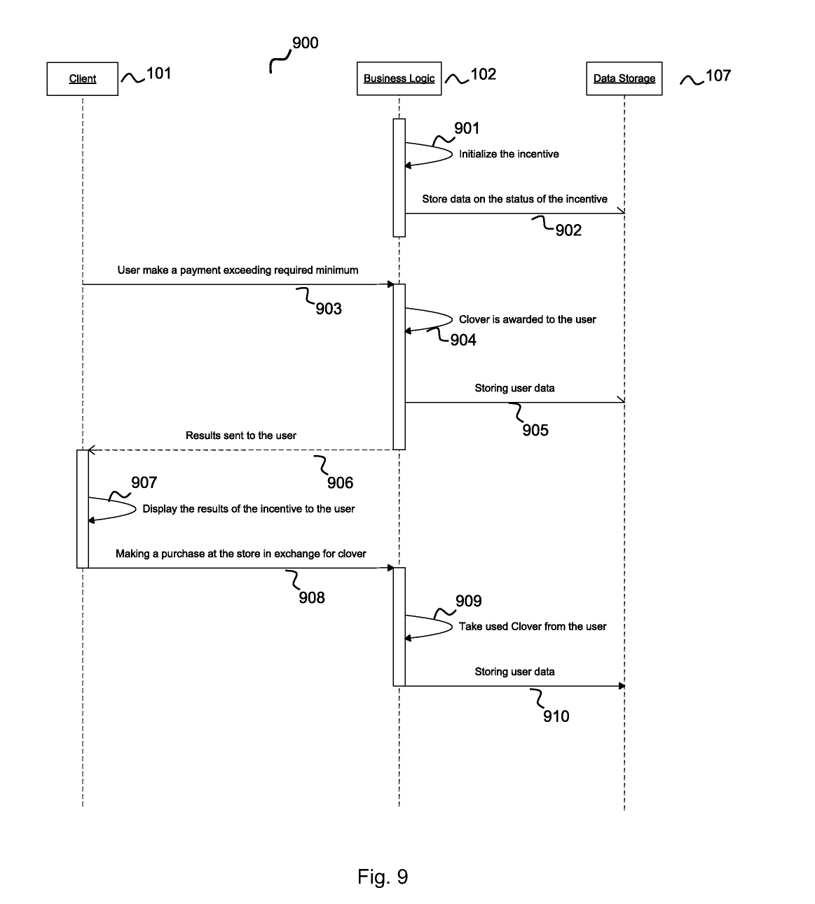

FIG. 9 illustrates an exemplary logical diagram 900 of interaction between client 101, gaming server 102 and data store 107 of an embodiment of an inventive system for keeping the Internet users engaged in online games using various incentives. The logical diagram 900 generally corresponds to the operating sequence 800 shown in FIG. 8. As in FIG. 8, in the embodiment shown in FIG. 9, the user is provided with a bonus in exchange for making a small payment. The process is initiated when the incentive initialization operation is performed at step 901. The incentive-related information generated during the initialization step is stored by the server 102 in the data store 107, see operation 902. At operation 903, the user performs the small payment, which exceeds a predetermined threshold amount, whereupon the bonus is provided to the user at operation 904. Subsequently, the information on the user and the awarded bonus is stored by the server 102 in the data store 107, see operation 905. At step 906, the information on the awarded bonus is provided by the gaming server 102 to the user's client computer system 101, where it is displayed to the user, see operation 907.

After being informed of the awarded bonus, the user make a store purchase request 908, which is handled by the gaming server 102. After the purchased item is delivered to the user, the used coupon or ticket is removed from user's account, see operation 909. Finally, the information on the user and the purchased item is stored by the server 102 in the data store 107, see operation 910.

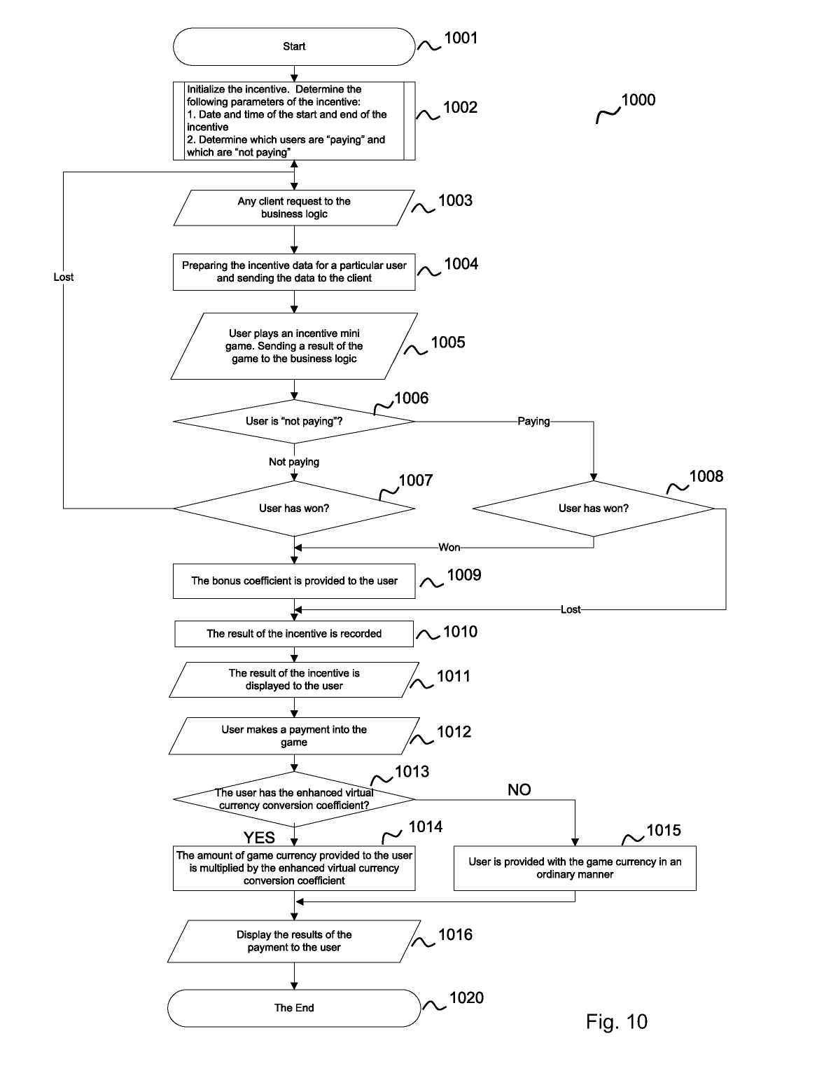

FIG. 10 illustrates an operating sequence 1000 of another exemplary embodiment of an inventive system for keeping the Internet users engaged in online games using various incentives. In the embodiment shown in FIG. 10, the users who have not made purchases of the virtual currency in the game are encouraged to make such purchases in order to receive a chance to double or triple their virtual currency on the next purchase. In one or more embodiments, this incentive is implemented as a mini-game within the game. In one or more embodiments, the inventive system generates an interface for playing dice. Depending on the dice through, the user is awarded a bonus, which can be in a form a multiplier for the next virtual currency purchase (x1.5; x2; x3). The user may also not win anything. In one or more embodiments, the game is configured such that the users who have recently made virtual currency purchase have very small chance of winning any bonus. On the other hand, the users without recent purchases have high chances of winning high multiplier bonus and small chances of not winning anything.

Turning back to the operating sequence of FIG. 10, the operating sequence starts with step 1001. At step 1002, the incentive initialization operation is performed. Specifically, during the initialization of the incentive, the inventive software: 1) determines the start and end date/time for the incentive; 2) separates the users into two categories of those who made recent currency purchases and those who did not. In one or more embodiments, the start and/or end date/time for the incentive may be randomly generated by the inventive software.

At step 1003, the server 102 receives a request 103 from the client 101. At step 1004, the information on the incentive for a specific user is prepared and sent to the client 101. At step 1005, the user plays the mini-game associated with the incentive. The result of that game is provided to the gaming server. At step 1006, the inventive software determines whether the user has made a recent virtual currency purchase. If so, the operation proceeds to step 1008. Otherwise, the operation proceeds to step 1007.

At both steps 1008 and 1007, the inventive gaming system determines whether the user won the incentive. The difference between steps 1008 and 1007 is in probability of user's winning, which in an embodiment of the invention would depend on the aforesaid user category. In case of user winning the bonus, the aforesaid enhanced virtual currency conversion coefficient is awarded to the user at step 1009. The details of the incentive award are recorded at step 1010 and displayed to the user at step 1011.

At step 1012, the user purchases virtual game currency. At step 1013, the system determines if the user was awarded the aforesaid enhanced virtual currency conversion coefficient. If so, the amount of virtual currency awarded to the user is proportionately increased by the aforesaid enhanced virtual currency conversion coefficient, which, in various embodiments, may range from x1.5 to x3, see step 1014. Otherwise, the standard amount of virtual currency is provided, see step 1015. At step 1016, the provided amount of virtual currency is displayed to the user, whereupon the operating sequence is terminated at step 1020.

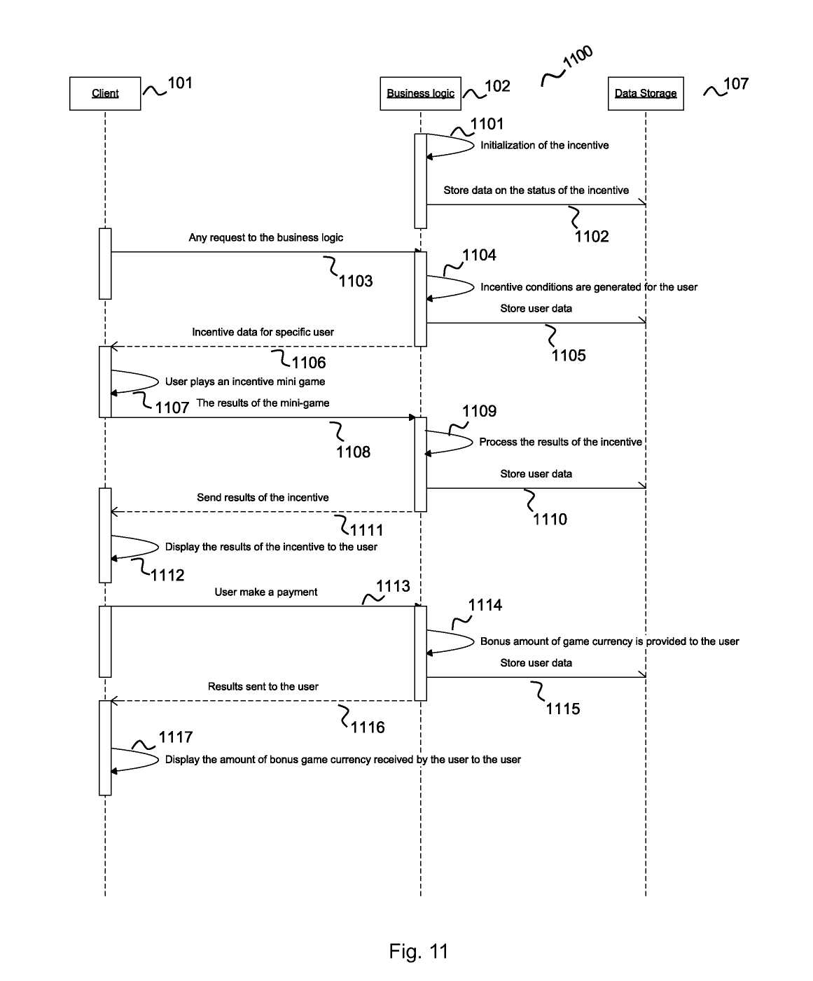

FIG. 11 illustrates an exemplary logical diagram 1100 of interaction between client 101, gaming server 102 and data store 107 of an embodiment of an inventive system for keeping the Internet users engaged in online games using various incentives. The logical diagram 1100 generally corresponds to the operating sequence 1000 shown in FIG. 10. As in FIG. 10, in the embodiment shown in FIG. 11, the user is encouraged to make such purchases in order to receive a chance to double or triple his or her virtual currency on the next purchase. The process is initiated when the incentive initialization operation is performed at step 1101. The incentive-related information generated during the initialization step is stored by the server 102 in the data store 107, see operation 1102.

At operation 1103, the server 102 receives a request 103 from the client 101. At operation 1104, the information on the incentive for a specific user is prepared. This information is stored by the server 102 in the data store 107, see operation 1105. The user-specific incentive information is sent by the server 102 to the client computer system 101 at operation 1106. At operation 1107, the user plays incentive mini-game. The results of the mini-game are returned by the client computer system 101 to the server 102 at operation 1108. The mini-game results are analyzed by the gaming server software and the appropriate bonus is awarded at 1109. The mini-game results for the user are stored at operation 1110. The results and the information on the bonus award are sent back to the client computer system 101 at 1111 and displayed to the user at 1112.

At 1113, the user makes a payment to the game operator in exchange for game's virtual currency. In response to the receipt of the payment, an additional, bonus virtual currency is awarded to the user at 1114. The information on the additional virtual currency award is stored in the data store at 1115 and sent back to the client computer system 101 at operation 1116. The sent information is displayed to the user at 1117.

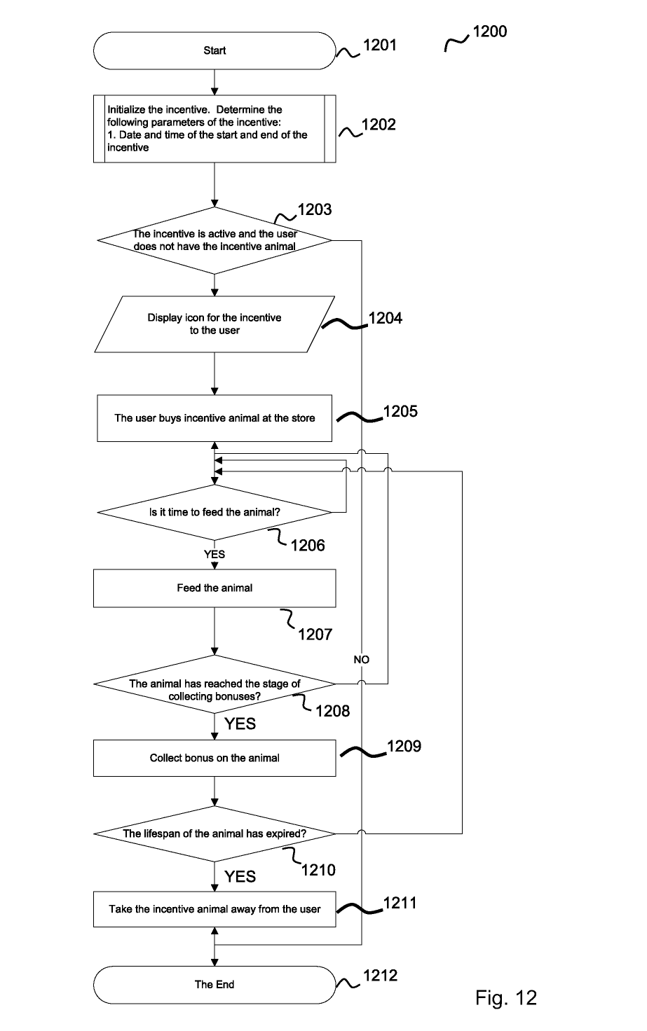

FIG. 12 illustrates an operating sequence 1200 of another exemplary embodiment of an inventive system for keeping the Internet users engaged in online games using various incentives. In the embodiment shown in FIG. 12, the users are offered to buy (in exchange for a payment in real-world currency) a virtual plant or a virtual animal, which generates a stream of income for the user in game's virtual currency, provided that the user spends sufficient time in the game. In one or more embodiments, the plant or animal may be bought only during the time when this incentive is active. In addition, the user must perform certain actions in the game (e.g. feed the animal) in order to receive the income therefrom.

Turning now to FIG. 12, the operating sequence starts with step 1201. At step 1202, the incentive initialization operation is performed. Specifically, during the initialization of the incentive, the inventive software determines the start and end date/time for the incentive. In one or more embodiments, the start and/or end date/time for the incentive may be randomly generated by the inventive software.

At step 1203, the inventive gaming software residing on the server 102 determines whether the user already possesses the plant or animal offered in this incentive. If yes, the user is not eligible to participate in the incentive and the operation terminates. Otherwise, the information about the incentive is displayed to the user at step 1204. At step 1205, the user is provided with the graphical interface enabling the user to purchase the virtual plant or animal in the game's store.

Subsequently, at step 1206, the inventive system determines whether it is time to feed the animal. The animal feeding interval may be predetermined in the gaming software system. If the feeding time arrived, the user is invited to fed the animal at step 1207. Next, the system determines if the time came for the animal or plant to generate a bonus for the user, see step 1208. If so, a bonus from the animal is awarded to the user at step 1209. At step 1210, the system checks whether the lifespan of the animal has expired. If yes, the animal is taken from the user at step 1211. The described operating sequence is terminated at step 1212.

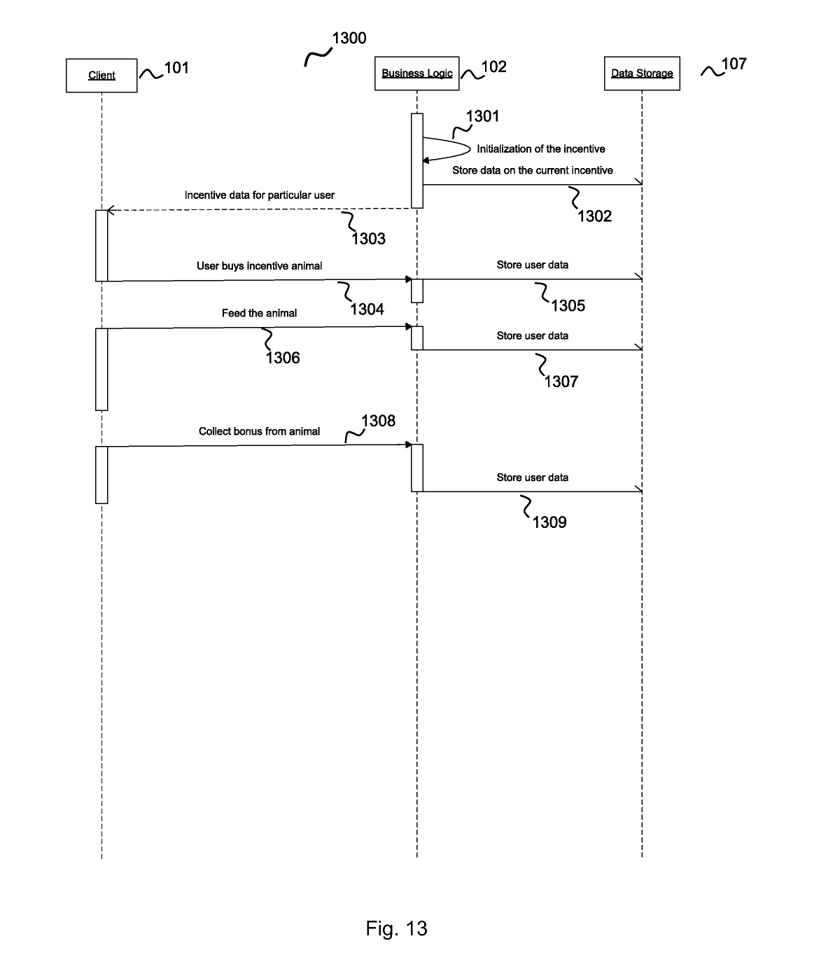

FIG. 13 illustrates an exemplary logical diagram 1300 of interaction between client 101, gaming server 102 and data store 107 of an embodiment of an inventive system for keeping the Internet users engaged in online games using various incentives. The logical diagram 1300 generally corresponds to the operating sequence 1200 shown in FIG. 12. As in FIG. 12, in the embodiment shown in FIG. 13, the user is offered to buy (in exchange for a payment in real-world currency) a virtual plant or a virtual animal, which generates a stream of income for the user in real-world currency, provided that the user spends sufficient time in the game.

With reference to FIG. 13, the process is initiated when the incentive initialization operation is performed at step 1301. The incentive-related information generated during the initialization step is stored by the server 102 in the data store 107, see operation 1302. At operation 1303, the information on the incentive for a specific user is prepared and subsequently sent by the server 102 to the client computer system 101. At operation 1304, the user makes the purchase of the plant or animal involved in the incentive. The information on the user's purchase of the plant or animal involved is stored by the gaming server 102 to the data store 107 in the operation 1305. At 1306, the user is provided with an interface allowing him or her to feed the virtual animal and the information on such user's action is sent by the client computer system 101 to the gaming server 102 in the operation 1306. This received information is also stored by the gaming server 102 in the data store 107, see operation 1307. Likewise, when the bonus time calculated by the system comes, the information on the bonus is received by the gaming server 102, see operation 1308 and stored in the data store 107, see operation 1309.

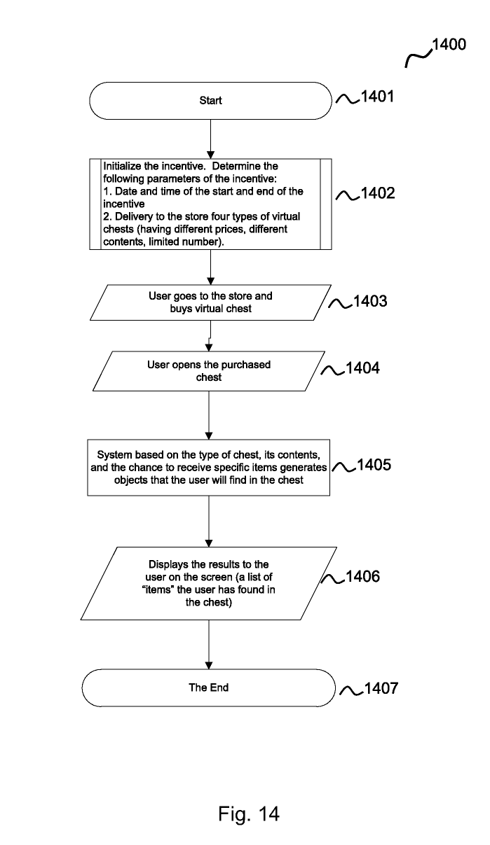

FIG. 14 illustrates an operating sequence 1400 of another exemplary embodiment of an inventive system for keeping the Internet users engaged in online games using various incentives. In the embodiment shown in FIG. 14, the users are offered to buy a virtual chest in exchange for virtual currency. In one or more embodiments, the purchase may only be made in a special virtual store, which is open only 3-5 days a month. At the time of the purchase, the user does not know the content of the chest. The higher is the purchase price, the higher is the probability that the chest contains rare or expensive virtual items.

Turning back to FIG. 14, the operating sequence starts with step 1401. At step 1402, the incentive initialization operation is performed. Specifically, during the initialization of the incentive, the inventive software determines: 1) the start and end date/time for the incentive; and 2) the types and prices of the virtual chests to be offered in the incentive. In one or more embodiments, the start and/or end date/time for the incentive may be randomly generated by the inventive software.

At step 1403, the inventive gaming software cause a user interface representing a virtual game store to be provided to the user, enabling the user to make a virtual purchase of the chest at step 1403. At step 1404, the system detects user's action of opening the purchased virtual chest. At step 1405, the inventive gaming software generates the items inside the chest based on the type of the chest purchased by the user. The information on the items inside the chest is provided to the user at step 1406, whereupon the process terminates at step 1407.

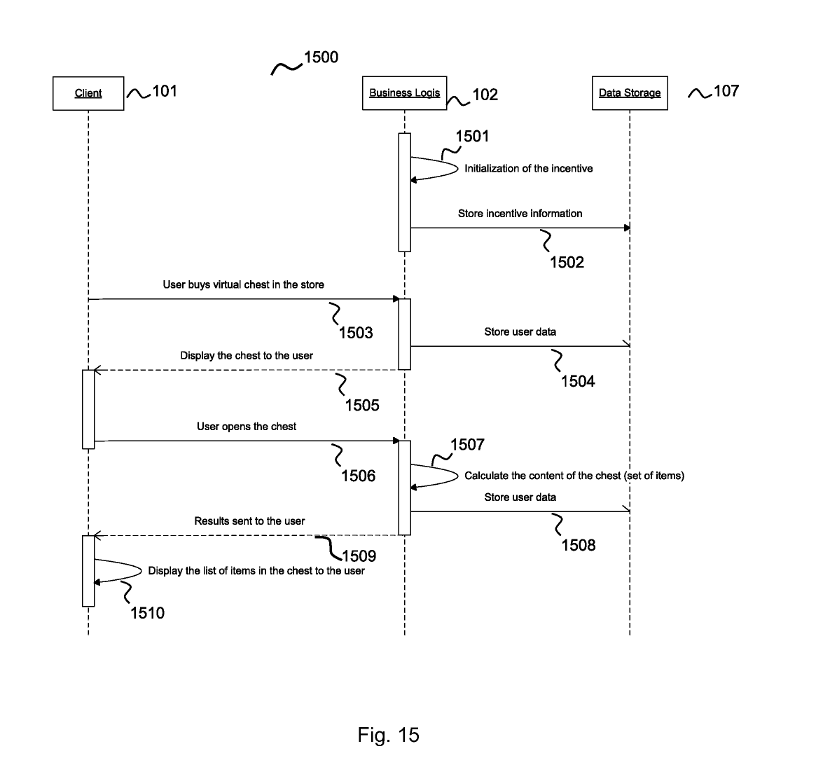

FIG. 15 illustrates an exemplary logical diagram 1500 of interaction between client 101, gaming server 102 and data store 107 of an embodiment of an inventive system for keeping the Internet users engaged in online games using various incentives. The logical diagram 1500 generally corresponds to the operating sequence 1400 shown in FIG. 14. As in FIG. 14, in the embodiment shown in FIG. 15, users are offered to buy a virtual chest in exchange for virtual currency.

With reference to FIG. 15, the process is initiated when the incentive initialization operation is performed at step 1501. The incentive-related information generated during the initialization step is stored by the server 102 in the data store 107, see operation 1502. At operation 1503, the user makes the purchase of the virtual chest in the game's virtual store. The information on the user's purchase of the chest is stored by the gaming server 102 to the data store 107 in the operation 1504. At 1505, the user is provided with a graphical representation of the purchased chest and with an interface allowing him or her to open the chest. At step 1506, the client computer system 101 detects user's action of opening the chest and sends information on this action to the gaming server 102. At operation 1507, the gaming software system determines the content of the chest. The chest content information is stored by the gaming server 102 in the data store 107, see operation 1508. At operation 1509, the generated information on the content of the virtual chest is sent from the server 102 to the client computer system 101, whereupon it is displayed to the user at 1510.

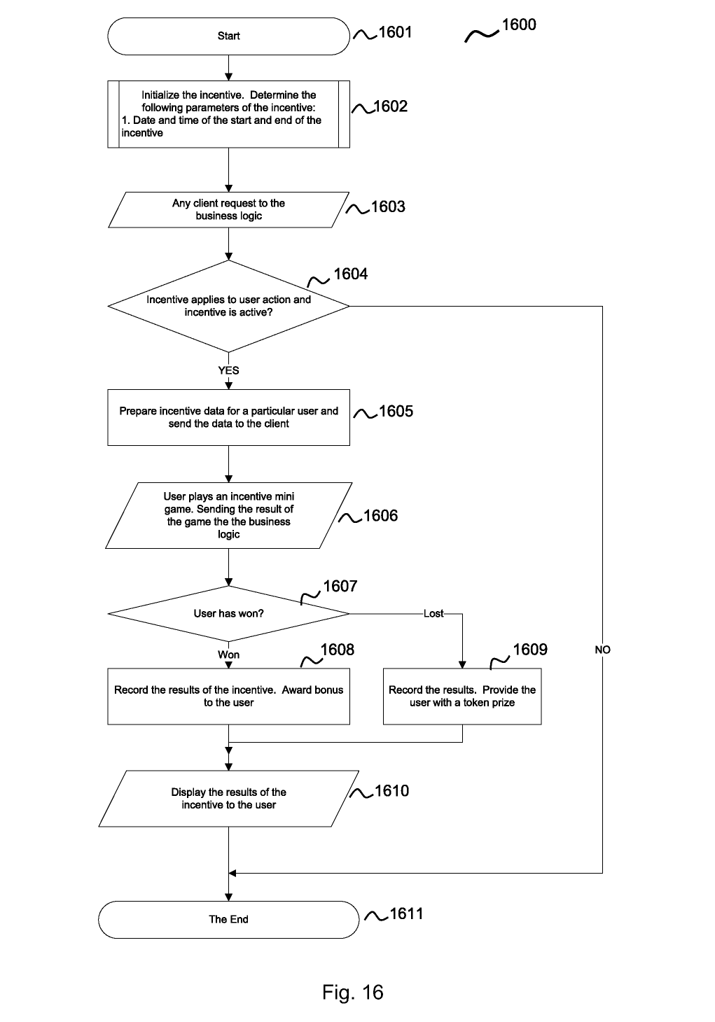

FIG. 16 illustrates an operating sequence 1600 of another exemplary embodiment of an inventive system for keeping the Internet users engaged in online games using various incentives. In the embodiment shown in FIG. 16, the users are asked to uncover coins hidden behind flowers in a field. If the user uncovers two sets of coins behind two flowers having equal number of coins, the user wins the aforesaid mini-game and is awarded a bonus. Otherwise, the user loses. Each try costs a predetermined amount of virtual currency. In one or more embodiment, the user is given an unlimited number of tries at this mini-game.

Turning back to FIG. 16, the operating sequence starts with step 1601. At step 1602, the incentive initialization operation is performed. Specifically, during the initialization of the incentive, the inventive software determines: the start and end date/time for the incentive. In one or more embodiments, the start and/or end date/time for the incentive may be randomly generated by the inventive software.

At step 1603, the server 102 receives a request 103 from the client 101. At step 1604, the inventive software operating on the server determines whether the actions of the user make him or her eligible for the incentive and whether the incentive is currently active. If the answer to both questions is in the affirmative, the operation proceeds to step 1605. Otherwise, the operation terminates. At step 1605, the information on the incentive for a specific user is prepared and sent to the client 101. At step 1606, the user plays the mini-game associated with the incentive. The result of that game is provided to the gaming server 102.

At step 1607, the inventive gaming system determines whether the user won the incentive. In case of user winning the bonus, the aforesaid bonus is provided to the user and the appropriate data records are created in the data store 107, see step 1608. Otherwise, the user is provided with a token prize at step 1609. The information on the awarded bonus is provided to the user at step 1610, whereupon the process terminates at step 1611.

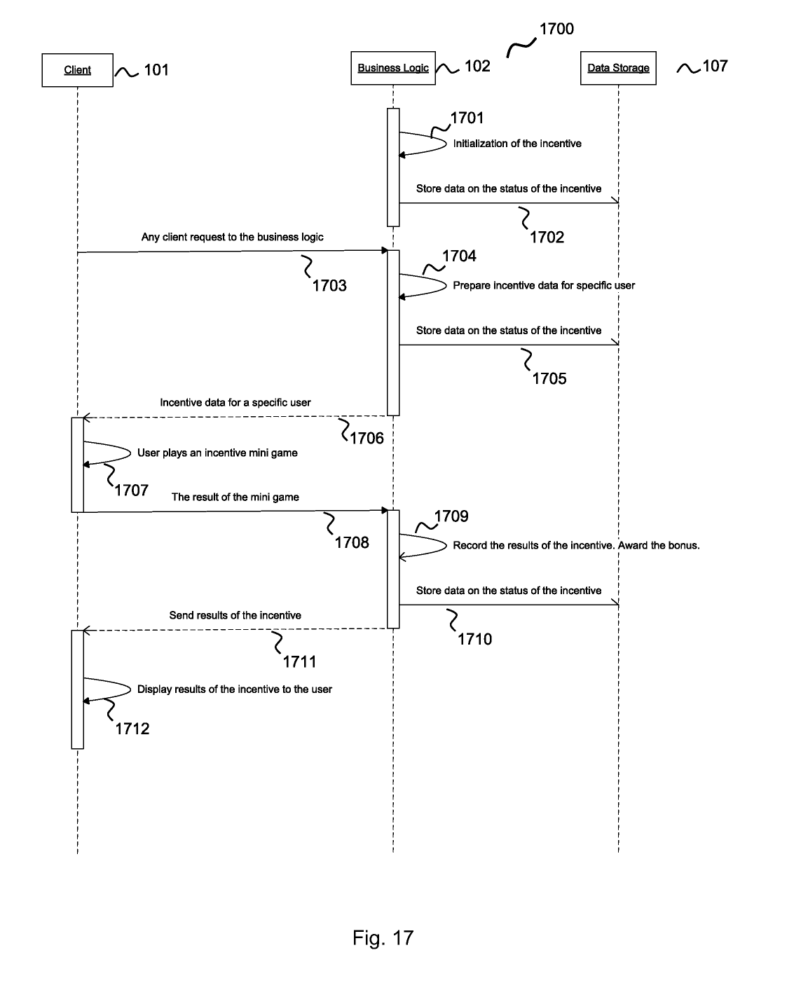

FIG. 17 illustrates an exemplary logical diagram 1700 of interaction between client 101, gaming server 102 and data store 107 of an embodiment of an inventive system for keeping the Internet users engaged in online games using various incentives. The logical diagram 1700 generally corresponds to the operating sequence 1600 shown in FIG. 16. As in FIG. 16, in the embodiment shown in FIG. 17, users are asked to uncover coins hidden behind flowers in a field.

With reference to FIG. 17, the process is initiated when the incentive initialization operation is performed at step 1701. The incentive-related information generated during the initialization step is stored by the server 102 in the data store 107, see operation 1702.

At operation 1703, the server 102 receives a request 103 from the client 101. At operation 1704, the information on the incentive for a specific user is prepared. This information is stored by the server 102 in the data store 107, see operation 1705. The user-specific incentive information is sent by the server 102 to the client computer system 101 at operation 1706. At operation 1707, the user plays incentive mini-game. The results of the mini-game are returned by the client computer system 101 to the server 102 at operation 1708. The mini-game results are analyzed by the gaming server software and the appropriate bonus is awarded at operation 1709. The mini-game results for the user are stored in the data store 107 at operation 1710. The results and the information on the bonus award are sent back to the client computer system 101 at 1711 and displayed to the user at 1712.

As it would be appreciated by those of skill in the art, the probability of the user selecting hidden sets of coins having equal number of coins may be equal to a predetermined value. This value would determine the success rate of the users and the amount of money generated by the described mini-game.

As it should be also appreciated by those of skill in the art, the inventive concept is not limited to only the described types of game incentives. Other types of incentives may also be used in the described gaming system without departing from the scope and spirit of the invention.

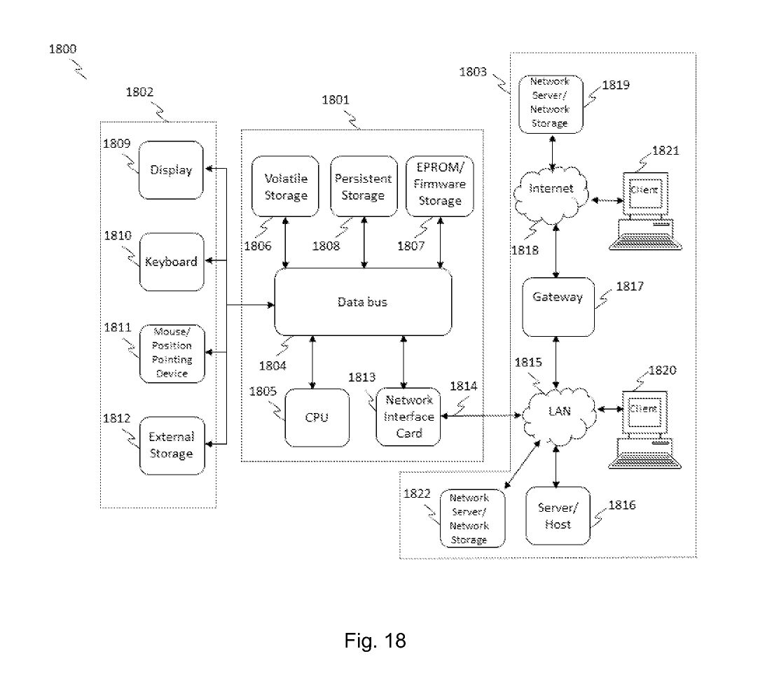

FIG. 18 illustrates an exemplary embodiment of a computer platform upon which the inventive system may be implemented. Specifically, FIG. 18 is a block diagram that illustrates an embodiment of a computer/server system 1800 upon which an embodiment of the inventive methodology may be implemented. The system 1800 includes a computer/server platform 1801, peripheral devices 1802 and network resources 1803.

The computer platform 1801 may include a data bus 1805 or other communication mechanism for communicating information across and among various parts of the computer platform 1801, and a processor 1805 coupled with bus 1801 for processing information and performing other computational and control tasks. Computer platform 1801 also includes a volatile storage 1806, such as a random access memory (RAM) or other dynamic storage device, coupled to bus 1805 for storing various information as well as instructions to be executed by processor 1805. The volatile storage 1806 also may be used for storing temporary variables or other intermediate information during execution of instructions by processor 1805. Computer platform 1801 may further include a read only memory (ROM or EPROM) 1807 or other static storage device coupled to bus 1804 for storing static information and instructions for processor 1805, such as basic input-output system (BIOS), as well as various system configuration parameters. A persistent storage device 1808, such as a magnetic disk, optical disk, or solid-state flash memory device is provided and coupled to bus 1801 for storing information and instructions.

Computer platform 1801 may be coupled via bus 1804 to a display 1809, such as a cathode ray tube (CRT), plasma display, or a liquid crystal display (LCD), for displaying information to a system administrator or user of the computer platform 1801. An input device 1810, including alphanumeric and other keys, is coupled to bus 1801 for communicating information and command selections to processor 1805. Another type of user input device is cursor control device 1811, such as a mouse, a trackball, or cursor direction keys for communicating direction information and command selections to processor 1805 and for controlling cursor movement on display 1809. This input device typically has two degrees of freedom in two axes, a first axis (e.g., x) and a second axis (e.g., y), that allows the device to specify positions in a plane.

An external storage device 1812 may be coupled to the computer platform 1801 via bus 1804 to provide an extra or removable storage capacity for the computer platform 1801. In an embodiment of the computer system 1800, the external removable storage device 1812 may be used to facilitate exchange of data with other computer systems.

The invention is related to the use of computer system 1800 for implementing the techniques described herein. In an embodiment, the inventive system may reside on a machine such as computer platform 1801. According to one embodiment of the invention, the techniques described herein are performed by computer system 1800 in response to processor 1805 executing one or more sequences of one or more instructions contained in the volatile memory 1806. Such instructions may be read into volatile memory 1806 from another computer-readable medium, such as persistent storage device 1808. Execution of the sequences of instructions contained in the volatile memory 1806 causes processor 1805 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1805 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 1808. Volatile media includes dynamic memory, such as volatile storage 1806.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 1805 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 1804. The bus 1804 carries the data to the volatile storage 1806, from which processor 1805 retrieves and executes the instructions. The instructions received by the volatile memory 1806 may optionally be stored on persistent storage device 1808 either before or after execution by processor 1805. The instructions may also be downloaded into the computer platform 1801 via Internet using a variety of network data communication protocols well known in the art.

The computer platform 1801 also includes a communication interface, such as network interface card 1813 coupled to the data bus 1804. Communication interface 1813 provides a two-way data communication coupling to a network link 1815 that is coupled to a local network 1815. For example, communication interface 1813 may be an integrated services digital network (ISDN) card or a modem to provide a data communication connection to a corresponding type of telephone line. As another example, communication interface 1813 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1813 sends and receives electrical, electromagnetic or optical signals that carry digital data streams representing various types of information.

Network link 1813 typically provides data communication through one or more networks to other network resources. For example, network link 1815 may provide a connection through local network 1815 to a host computer 1816, or a network storage/server 1817. Additionally or alternatively, the network link 1813 may connect through gateway/firewall 1817 to the wide-area or global network 1818, such as an Internet. Thus, the computer platform 1801 can access network resources located anywhere on the Internet 1818, such as a remote network storage/server 1819. On the other hand, the computer platform 1801 may also be accessed by clients located anywhere on the local area network 1815 and/or the Internet 1818. The network clients 1820 and 1821 may themselves be implemented based on the computer platform similar to the platform 1801.

Local network 1815 and the Internet 1818 both use electrical, electromagnetic or optical signals that carry digital data streams. The signals through the various networks and the signals on network link 1815 and through communication interface 1813, which carry the digital data to and from computer platform 1801, are exemplary forms of carrier waves transporting the information.

Computer platform 1801 can send messages and receive data, including program code, through the variety of network(s) including Internet 1818 and LAN 1815, network link 1815 and communication interface 1813. In the Internet example, when the system 1801 acts as a network server, it might transmit a requested code or data for an application program running on client(s) 1820 and/or 1821 through Internet 1818, gateway/firewall 1817, local area network 1815 and communication interface 1813. Similarly, it may receive code from other network resources.

The received code may be executed by processor 1805 as it is received, and/or stored in persistent or volatile storage devices 1808 and 1806, respectively, or other non-volatile storage for later execution.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, pen, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in systems and methods for keeping Internet users engaged in online games using game incentives. It is intended that the specification and examples be considered as exemplary only, with a true scope and spirit of the invention being indicated by the following claims.

1. A computer-implemented method performed in a system comprising a central processing unit, a memory and a network interface, the method comprising:
a. Receiving a request from a client system operated by a user, the request containing information on the identity of the user, the request being issued by the client system in connection with a game played by the user;
b. Using the received information on the identity of the user to prepare a user-specific game incentive information;
c. Providing the prepared user-specific game incentive information to the client system, the user-specific information causing the client system to display a user interface for a mini-game to the user;
d. Receiving from the client system the results of the mini-game played by the user;
e. Awarding a game incentive to the user based on the received results of the mini-game played by the user;
f. Storing information on the awarded game incentive in a data store;
g. Providing the information on the awarded game incentive to the client system; and
h. Causing the information on the awarded game incentive to be displayed to the user.

2. The computer-implemented method of claim 1, wherein preparing the user-specific game incentive information comprises determining the start and end times of the time period when the game incentive is active.

3. The computer-implemented method of claim 2, wherein preparing the start and end times of the inventive are randomly generated.

4. The computer-implemented method of claim 2, wherein awarding a game incentive comprises awarding additional points based on a point multiplier for user's actions in the game during the time when the incentive is active.

5. The computer-implemented method of claim 1, wherein awarding a game incentive comprises enabling a user to spin a virtual wheel and receive one or more virtual items based on predetermined probabilities.

6. The computer-implemented method of claim 1, wherein awarding a game incentive comprises awarding the user a coupon and exchanging the awarded coupon for any item in a virtual store associated with the game.

7. The computer-implemented method of claim 1, wherein awarding a game incentive comprises awarding the user an increased amount of virtual currency at the next virtual currency purchase.

8. The computer-implemented method of claim 1, wherein awarding a game incentive comprises providing the user with a virtual animal and awarding the user a real currency payment for performing predetermined actions in relation to the virtual animal.

9. The computer-implemented method of claim 1, wherein awarding a game incentive comprises providing the user with a virtual chest, determining the content of the virtual chest and displaying information on the determined content of the chest to the user.

10. The computer-implemented method of claim 1, wherein awarding a game incentive comprises providing the user with virtual currency payment in response to a predetermined action.

11. The computer-implemented method of claim 10, wherein the predetermined action comprises a selection of two hidden sets of coins having equal number of coins.

12. A computerized system comprising a central processing unit, a memory and a network interface, the memory storing a set of instructions causing the central processing unit to perform a method comprising: Receiving a request from a client system operated by a user, the request containing information on the identity of the user, the request being issued by the client system in connection with a game played by the user;
Using the received information on the identity of the user to prepare a user-specific game incentive information;
Providing the prepared user-specific game incentive information to the client system, the user-specific information causing the client system to display a user interface for a mini-game to the user;
Receiving from the client system the results of the mini-game played by the user;
Awarding a game incentive to the user based on the received results of the mini-game played by the user;
Storing information on the awarded game incentive in a data store; Providing the information on the awarded game incentive to the client system; and
Causing the information on the awarded game incentive to be displayed to the user.

13. The computerized system of claim 12, wherein preparing the user-specific game incentive information comprises determining the start and end times of the time period when the game incentive is active.

14. The computerized system of claim 13, wherein preparing the start and end times of the inventive are randomly generated.

15. The computerized system of claim 13, wherein awarding a game incentive comprises awarding additional points based on a point multiplier for user's actions in the game during the time when the incentive is active.

16. The computerized system of claim 12, wherein awarding a game incentive comprises enabling a user to spin a virtual wheel and receive one or more virtual items based on predetermined probabilities.

17. The computerized system of claim 12, wherein awarding a game incentive comprises awarding the user a coupon and exchanging the awarded coupon for any item in a virtual store associated with the game.

18. The computerized system of claim 12, wherein awarding a game incentive comprises awarding the user an increased amount of virtual currency at the next virtual currency purchase.

19. The computerized system of claim 12, wherein awarding a game incentive comprises providing the user with a virtual animal and awarding the user a real currency payment for performing predetermined actions in relation to the virtual animal.

20-22. (canceled)

23. A tangible computer-readable medium embodying a set of computer instructions, which, when executed by a system comprising a central processing unit, a memory and a network interface, cause the system to perform a method comprising:
a. Receiving a request from a client system operated by a user, the request containing information on the identity of the user, the request being issued by the client system in connection with a game played by the user;
b. Using the received information on the identity of the user to prepare a user-specific game incentive information;
c. Providing the prepared user-specific game incentive information to the client system, the user-specific information causing the client system to display a user interface for a mini-game to the user;
d. Receiving from the client system the results of the mini-game played by the user;
e. Awarding a game incentive to the user based on the received results of the mini-game played by the user;
f. Storing information on the awarded game incentive in a data store;
g. Providing the information on the awarded game incentive to the client system; and
h. Causing the information on the awarded game incentive to be displayed to the user.

24-33. (canceled)
